(19) United States
(12) Patent Application Publication
(10) Pub. No.: US 2009/0086948 A1
(43) Pub. Date: Apr. 2, 2009

(54) Method and apparatus for managing audio conferencing

(76) Inventors: Nidhi Narang, Fremont, CA (US); Suneetha Tirumalai, Sunnyvale, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/904,954

(22) Filed: Sep. 27, 2007

(51) Int. Cl. H04M 3/42

(52) U.S. Cl. 379/202.01

(57) ABSTRACT

A telecommunications system, including a network; a plurality of user devices operably coupled to the network; and a teleconferencing system operably coupled to the network, the teleconferencing system including a hosting service configured to allow a moderator to set up and schedule a teleconference among a plurality of participant user devices and an announcement service configured to allow for distributing moderator-defined information to the participants by automatically sending the moderator information as moderator-selected media upon a log in to the conference.

### BACKGROUND OF THE INVENTION

1. Field of the Invention

This invention relates to audio conferencing. More particularly, the invention relates to methods for presenting user information to other parties and managing a media conference.

2. Description of the Related Art

Audio conferencing is becoming an increasingly popular and important component of modern business and social interaction. In order to establish an audio conference, a party, typically known as a “moderator,” selects a time, reserves a conference session at a conferencing server or service, and is provided with a conference access code. At the time of the conference, parties can call in to the service and enter the access code. They are then given access to the audio conference.

Often the moderator may wish to share documents, whiteboarding, etc., in conjunction with the audio conference. To do so, the moderator may make use of a tool such as NetMeeting. However, in order to successfully implement a NetMeeting conference, the moderator's IP address must be provided to each participant. As can be appreciated, having to announce this information, or similar information, every time a party enters the conference can be disruptive and time-consuming.

As such, there is a need for an announcement system in multimedia conferences that does not disrupt an ongoing audio conference.

### SUMMARY OF THE INVENTION

These and other drawbacks in the prior art are overcome in large part by a system and method according to embodiments of the present invention.

A telecommunications system in accordance with embodiments of the present invention includes a network; a plurality of network clients including an announcement client; and a conferencing service including an announcement service. The announcement client is configured to allow a party to make or record one or more announcements that can be played out to parties joining the conference, prior to their joining. In a unified messaging system, if the announcement pertains to, for example, a postponement of the conference, an e-mail or calendar update may be provided, as well.

A program product stored on one or more computer readable devices according to embodiments of the present invention includes code that allows a moderator to set one or more conference announcements which can be played to conference participants as they join the conference. In some embodiments, confirmations may be sent via e-mail or other media as well.

A telecommunications system in accordance with embodiments of the present invention includes a network; a plurality of user devices operably coupled to the network; and a teleconferencing system operably coupled to the network, the teleconferencing system including a hosting service configured to allow a moderator to set up and schedule a teleconference among a plurality of participant user devices and an announcement service configured to allow for distributing moderator-defined information to the participants by automatically sending the moderator information as moderator-selected media upon a log in to the conference.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates an exemplary system in accordance with embodiments of the present invention.

FIG. 2 illustrates an exemplary system in accordance with embodiments of the present invention.

FIG. 3 is a flowchart illustrating operation of an embodiment of the present invention.

FIG. 4 illustrates an exemplary system in accordance with embodiments of the present invention.

FIG. 5 is a flowchart illustrating operation of an embodiment of the present invention.

FIG. 6 is a diagram illustrating operation of an embodiment of the present invention.

FIG. 7 is a diagram of a graphical user interface for use with a system in accordance with embodiments of the present invention.

FIG. 8 is a diagram of a system in accordance with embodiments of the present invention.

### DETAILED DESCRIPTION OF EMBODIMENTS OF THE INVENTION

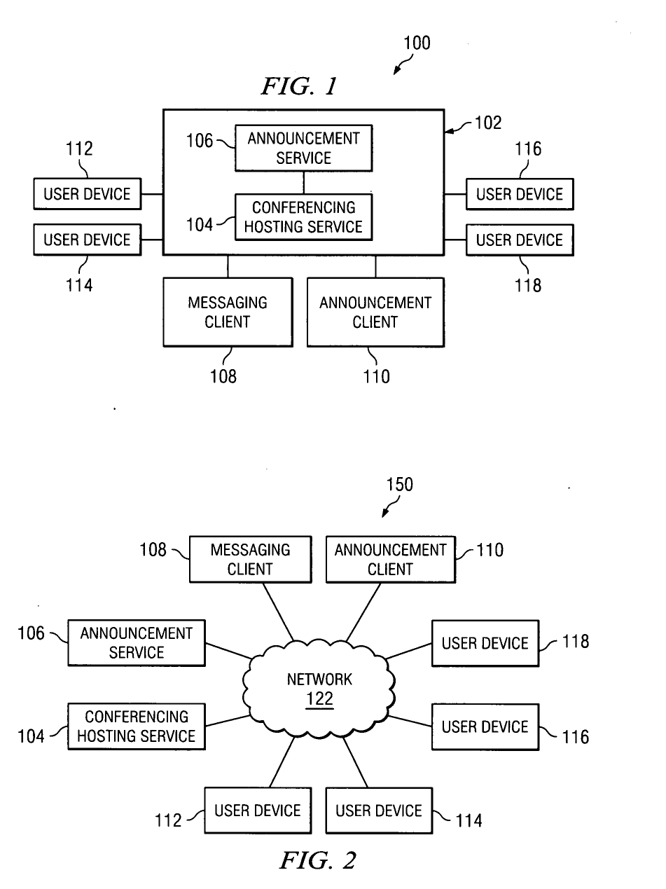

Turning now to the drawings and, with particular attention to FIG. 1, a diagram of a telecommunications system 100 according to an embodiment of the present invention is shown. The system 100 includes a conferencing service 102 including or in communication with a conference hosting service 104 and an announcement service 106 in accordance with embodiments of the present invention. In certain embodiments, the conferencing service 102 may be implemented as personal computers or servers operating as World Wide Web Internet or intranet servers.

One or more messaging clients 108 and announcement clients 110 may be coupled to or in communication with the conferencing service 102. As will be explained in greater detail below, the messaging client 108 may be embodied as a telephony client or a Unified Messaging Client; the announcement client 110 may be implemented in conjunction with the telephony client or a Unified Messaging Client to provide conference announcement functions in accordance with embodiments of the present invention.

User devices, such as user devices 112, 114, 116, 118 may be connected to or in communication with the conferencing service 102 and messaging client 108 and announcement client 110. In certain embodiments, the user devices 112, 114, 116, 118 may be implemented as telephones, cellular telephones, PDAs, PocketPCs, computers, etc. For example, user devices 112, 114, 116, 118 may be embodied as personal computers implementing the Windows XP or Vista operating system and a web browser, respectively, such as the Microsoft Explorer or Mozilla Firefox web browser.

As will be discussed in greater detail below, a party may use his messaging client 108 to reserve a conference session with the conference hosting or setup service 104. At this time, or at any time prior to or during the conference, he or she may, using his announcement client 110, record or enter one or more announcement messages or conference details that may be provided to other parties upon their joining or registering to the conference. The announcement is received by the announcement service 106, which then, in conjunction with the conference hosting service 104, may be played or distributed as an audio message or using other media capabilities of a unified messaging system. In systems having a unified messaging system, the announcement may be e-mailed or text messaged to the other conference parties either prior to the start of the conference or in response to their calling in to the conference, or both.

As will be discussed in greater detail below, the conferencing service 102 and its components, as well as the messaging and announcement clients 108, 110, may be implemented in hardware and/or software operating on one or more servers, computer systems, host or mainframe computers, workstations, etc. In some embodiments, the conferencing service 102, as well as the messaging and announcement clients 108, 110 may be operating on some or all of the same devices as other components in the system 100.

In certain embodiments, the system 100 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the system 100 and allow the registration of SIP devices in the system 100.

In certain embodiments of the present invention, one or more of the components of the system 100 may be connected to or in communication with each other via a communication network. For example, turning now to FIG. 2, a system 150 including the components of the system 100 is illustrated, wherein some or all of the components are in communication via a network 122. The network 122 may be or include the Internet, World Wide Web, a local area network, or some other public or private computer, cable, telephone, client/server, peer-to-peer, or communication network or intranet.

In some embodiments, the communication network can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, the public switched telephone network (PSTN), etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

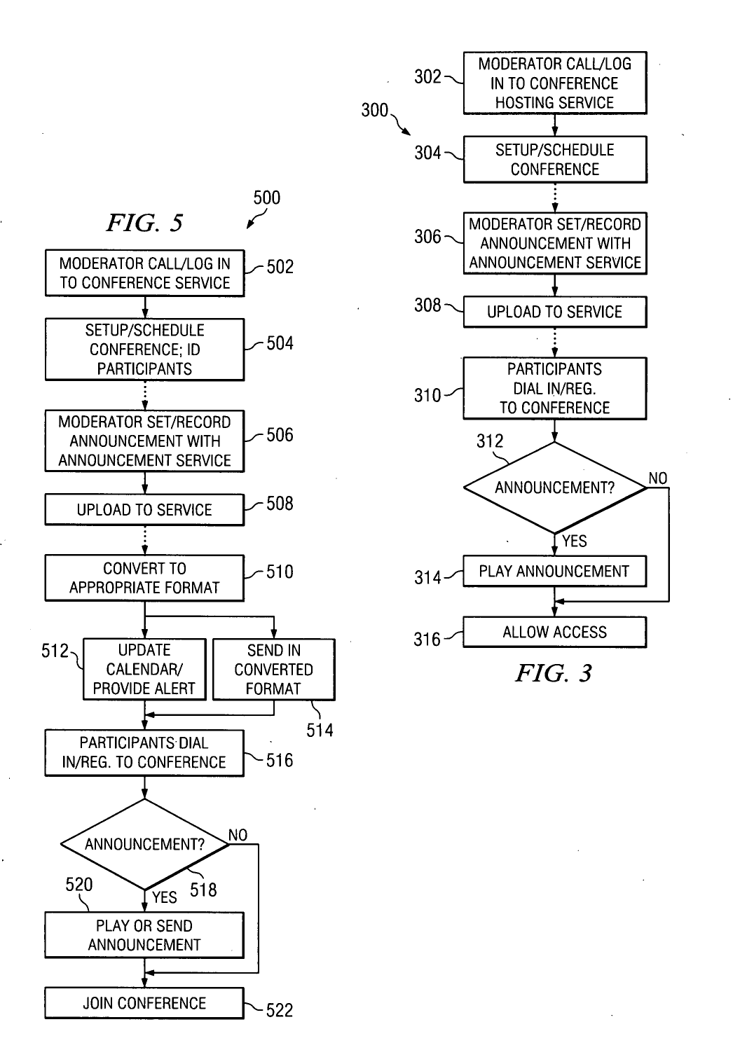

Operation of an embodiment of the present invention is explained in greater detail below with reference to FIG. 3, in which a flowchart 300 is shown. The particular arrangement of elements in the flowchart 300 is not meant to imply a fixed order to the elements; embodiments can be practiced in any order that is practicable.

Initially, in a step 302, a user (typically the conference moderator), can employ his messaging client 108 to call or log in to the conference hosting service 104. As discussed above, in some embodiments, the messaging client 108 may be embodied as a telephone or telephony client. Thus, calling in can include dialing an appropriate toll-free number or other number and connecting via the public switched telephone network.

In a step 304, the user-moderator can set up or schedule the conference with the conference hosting service 104. As discussed above, this can include setting a time and date and receiving an access code, for example, by interacting with an interactive voice response system at the conference hosting service 104.

In a step 306, the user-moderator can set or record an announcement, either at the time of the setup or at a later time. For example, the user-moderator can speak into a microphone and record a voice message using or via his announcement client 110 and messaging client 108 (It is noted that, while separate announcement and messaging clients are illustrated, in practice, they may not be separate entities; thus, the figures are exemplary only). In some embodiments, the announcement may be recorded at the client 110 and uploaded to the service; in others, it may be directly recorded at the announcement service 106. Alternatively, the user can type in a message as text; depending on the embodiment, the message can then be converted to voice using text to speech techniques, either at the client 110 or at the service 106 directly.

The announcement may be of any type; for example, in some embodiments, the announcement may be of an IP address for a multimedia session accompanying the audio conference. In other embodiments, the announcement may be of a postponement of the meeting. It is noted that, if the announcement is generated and/or uploaded at a later time, the moderator would log in to the conference hosting service and identify the conference, for example, by inputting the conference passcode.

The announcement may then be uploaded to the conferencing service 102 and, particularly, to the announcement service 106, in a process step 308. The announcement service 106 can then convert the text to speech or simply receive audio, if directly input, or an audio file, if originally recorded at the client. The announcement-service 106 further correlates the announcement with the particular conference, e.g., by associating the announcement with the respective conference identification or access code, or with participants or prospective participants to a particular conference.

In a step 310, at the designated time of the conference, the parties to the conference can dial in to the server 102 and input their access codes to register for the conference. In a process step 312, the announcement service 106 checks to see if any announcements are associated with the particular code. If so, then in a process step 314, the announcement is played to the calling party, and the calling party can then join the conference, in a process step 316. If, in process step 312, there was no announcement, then the party, having been authenticated by the conference system, will simply be allowed to join.

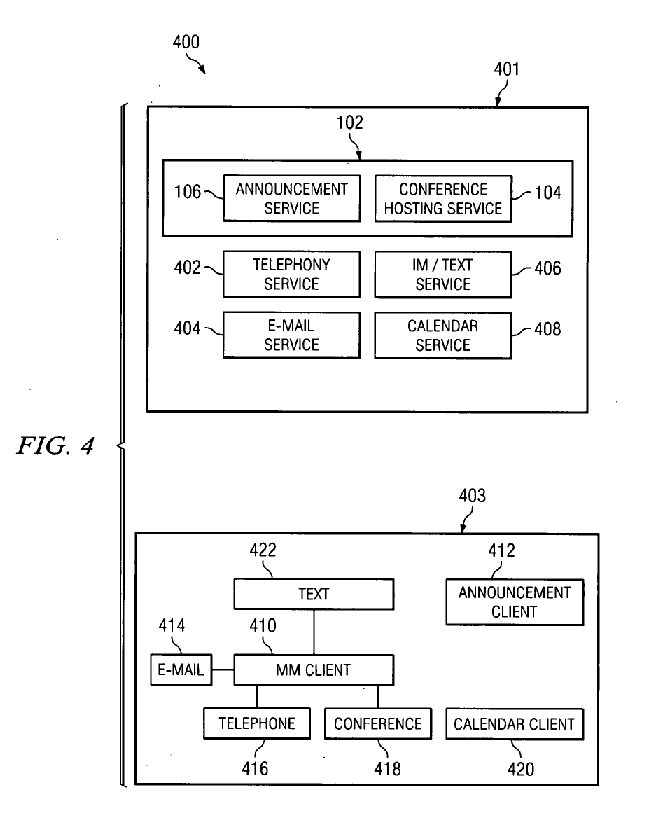

As noted above, according to some embodiments of the present invention, the announcement service and/or clients are provided in conjunction with a unified messaging system. In such a messaging system, as will be explained in greater detail below, an announcement may be delivered in or as one or more user-selectable media. FIG. 4 is a block diagram illustrating various components of a multimodal telecommunications system including a multimedia messaging system that may be operably coupled to or in communication with the system of embodiments of the present invention.

As shown, the system 400 includes a conference system 102 including or in communication with a conference hosting service 104 and announcement service 106. In addition, the system includes a telephony service 402, a text/IM service 406, an e-mail service 404, as well as a calendar service 408. It is noted that, while particular message or communication services are shown, the invention is not so limited.

A client 403 in accordance with embodiments of the present invention thus includes or is in communication with a messaging client 410 and an announcement client 412. The messaging client 410 may implement a telephony client 416, a conferencing client 418, and an e-mail client 414, as well as a text messaging client 422 and a calendar client 420. Typically, the messaging clients are implemented as a common browser-based interface, capable of communicating with the service 401.

An exemplary server environment capable of being adapted for use in a system according to embodiments of the present invention is the OpenScape system, available from Siemens Communications, Inc. Such an environment can be implemented, for example, in conjunction with Windows Server, Microsoft Office Live Communications Server, Microsoft Active Directory, Microsoft Exchange and SQL Server.

In operation, as will be explained in greater detail below, a moderator can set an announcement, such as by speaking or typing it in, in a manner similar to that discussed above. When the conference is identified, the announcement can be converted to an appropriate format and/or sent as an attachment in an appropriate medium to parties when they log in to the conference. In other embodiments, the parties to the conference can be specified such that they receive a calendar or message update immediately, with or without a follow-up upon joining the conference. Other, later joining parties may receive the message when they call in.

For example, in some embodiments, the announcement may be in a speech form. The announcement can either be attached as a file to an e-mail message, or can be converted to text and either sent as the body of an e-mail or text message, or attached as a document file and sent with the e-mail. Alternatively, or in addition, the system can access the calendar service 408 and determine that some change is to be made to the conference, such as start time or date, and can provide a corresponding update or alert indicating that a related message has been sent.

Turning now to FIG. 5, a flowchart 500 illustrating operation of embodiment of the present invention is shown. The particular arrangement of elements in the flowchart 500 is not meant to imply a fixed order to the elements; embodiments can be practiced in any order that is practicable

Initially, in a step 502, a user (typically the conference moderator) can employ his messaging client 410 to call or log in to the conference hosting service 104. As discussed above, this can include dialing an appropriate toll-free number or other number and connecting via the public switched telephone network using, e.g., a telephone or telephony client 416. In other embodiments, the moderator can employ a web-browser type interface to connect with the conference hosting service 104.

In a step 504, the user-moderator can set up or schedule the conference with the conference hosting service 104. As discussed above, this can include setting a time and date and receiving an access code. In addition, in the embodiment illustrated, this can include identifying one or more of the prospective participants to the conference. For example, the user could enter the participants' names or simply their phone numbers.

In a step 506, the user can set or record an announcement, either at the time of the setup or at a later time. For example, as discussed above, the user-moderator can speak into a microphone and record a voice message using or via his announcement client 412. In some embodiments, the announcement may be recorded at the client; at others, it may be directly recorded at the announcement service. Alternatively, the user can type in a message as text; depending on the embodiment, the message can then be converted to voice using text to speech techniques, either at the client or at the service directly.

The announcement may then be uploaded or otherwise received at the conferencing service 102 and, particularly, to the announcement service 106, in a process step 508. The announcement service 106 further correlates the announcement with the particular conference.

In a process step 510, the announcement service 106 can then convert the text to speech using, for example, known techniques, or simply receive audio, if directly input, or an audio file, if originally recorded at the client. More generally, in process step 510, the announcement service 106 converts the received announcement to a desired, typically user-specified format. For example, as discussed above, this can include converting to a text format suitable for e-mail or text message transmission, or into a document or other suitable file format for attachment to an electronic message, such as e-mail.

In a step 512, the system accesses the entered party identification and the calendar service 408 may update a calendar entry for the corresponding parties (if the announcement relates). This can include, for example, providing additional information or indicia of a change in meeting plans. In a step 514, the announcement service 106 can access the participant identities and cause the appropriate messaging service to send the announcement as a message.

In a step 516, at the designated time of the conference the parties to the conference can dial in to the server 102 and input their access codes. In a process step 518, the announcement service 106 checks to see if any announcements are associated with the particular code. If so, then in a step 512, the announcement may be played or otherwise sent to the calling party, and the calling party can then join the conference, in a process step 516. If, in process step 512, there was no announcement, then the party will simply be allowed to join upon authentication.

It is noted that parties not specifically identified can still receive the message when they log in to the conference. In some embodiments, an audio announcement is repeated when the user calls in; for other types of announcements, they may also be sent when the participant logs in.

It is noted that, in some embodiments, the announcement may be recorded by the moderator at any time, including during the conference itself. The announcement can then be played out to new parties as they enter the conference. The functions of the announcement service and the announcement client may be combined into a single unit at the conferencing service; thus a separate, local announcement client is not necessarily required.

It is noted that, in some embodiments, the conferencing system may be shared among users. Thus, when a message or announcement is left, it may have an automatic expiration time. Such an expiration time may be, for example, the ending of the conference or a predetermined time thereafter.

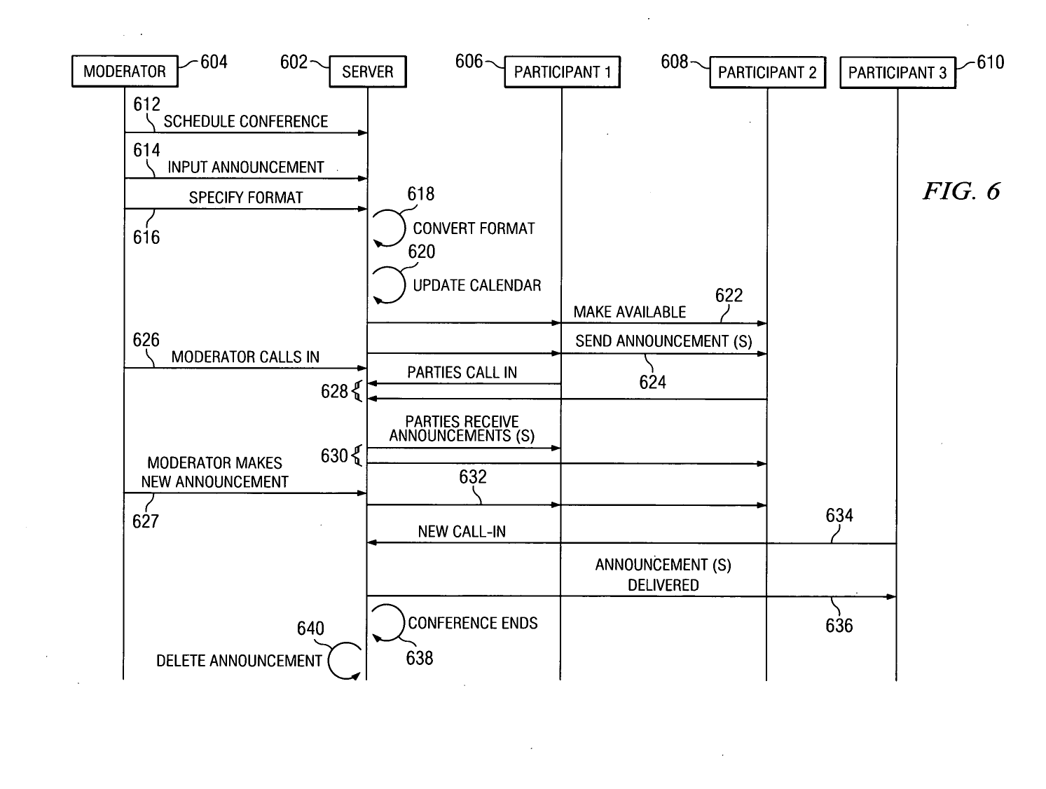

FIG. 6 is a diagram schematically illustrating operation of embodiments of the present invention. Shown are an exemplary server 602, a moderator 604, and other participants 606, 608, 610.

As shown at 612, the moderator 604 may call in or otherwise log in to the conferencing server 602 to schedule a conference. As discussed above, the moderator may use a telephony connection via, e.g., the public switched telephone network using an interactive voice response-type interface, or an Internet-type connection using a web browser-type graphical interface. The moderator may define a time and a date for the conference and may further identify prospective participants to the conference. For example, the moderator may define a conference including participant 1 606 and participant 2 608.

At 614, at the time of conference setup or later, the moderator 604 can input an announcement and, at 616, can specify a format for the announcement. As discussed above, the announcement can be, e.g., spoken into a microphone and received over a voice connection, or can take the form of an audio or text file that is transmitted or uploaded to the server 602. The moderator can then specify the transmission format, e.g., whether it is delivered by voice or as a transmitted e-mail or other message. The moderator may also specify whether calendars associated with the parties are to be updated, or alerted to an announcement associated with the conference.

Thus, at 618, the server 602 can convert the incoming announcement to the transmission format and, at 620, can update the respective calendars. The calendar may be a single calendar maintained for a group, for example, or may be individual calendars associated with the prospective participants.

At 622, the server 602 can make the calendar or calendar annotation available to the participants. This can include, for example, updating a web page maintained in association with the conference access code or by transmitting an update to the parties identified by the moderator.

Also, depending on the announcement, the server 602 can have one of the messaging services send the announcement out to the prospective conference participants, at 624. This depends, of course, on the server 602 being able to identify such participants.

At 626, the moderator can dial in to the server for the conference; other parties can do so, as well, as shown at 628. At 630, the announcement may be delivered again to the parties as they log in, since they may have missed its original transmission. The announcement may be delivered in the same format or in the audio format described above or both.

At a further time during the conference, at 627, the moderator may decide to make and record a new announcement. The message may be delivered to the other parties 606, 608 at 632. At 634, a new party 610, not previously identified, may call in to the conference. He may receive any previously set announcements, at 636.

The conference may end at 638, with all parties disconnecting. At 640, the conference server 602 may delete the announcement.

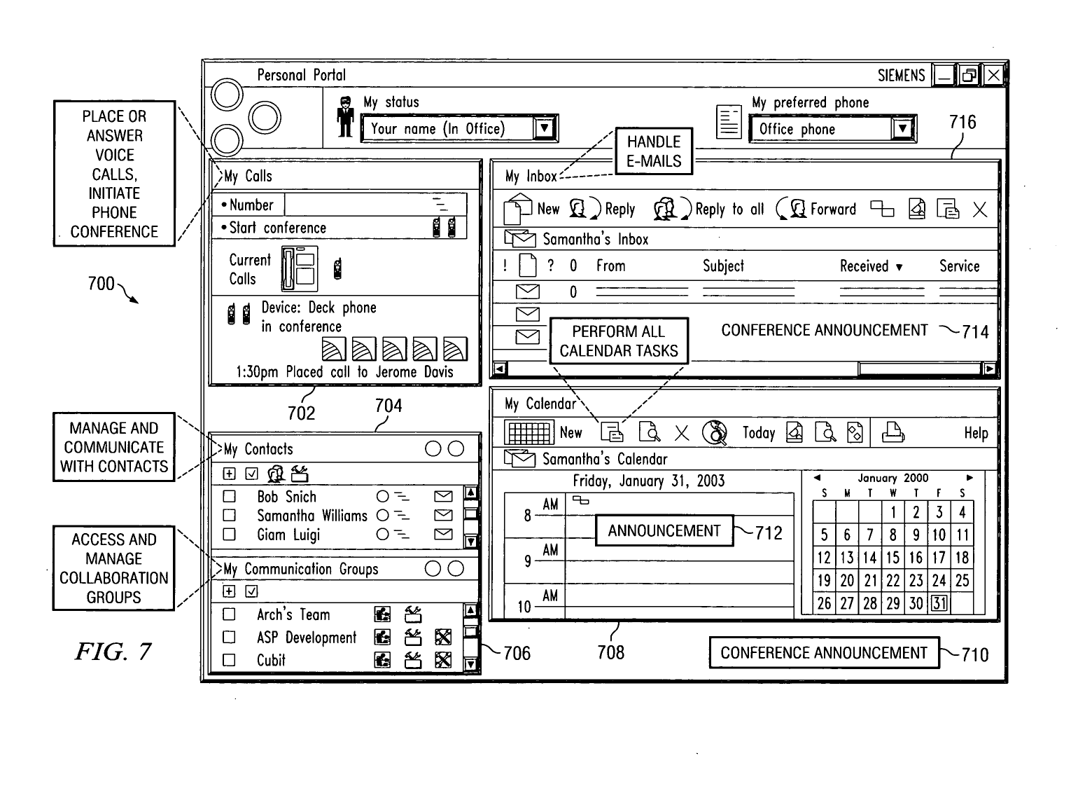

As noted above, in some embodiments, the messaging and announcement clients are part of an integrated, unified messaging system. An exemplary browser-type graphical user interface for such a system is shown in FIG. 7. In particular, interface 700 shows a personal portal for such a system. In the embodiment illustrated, the personal portal 700 includes call status indicia 702, contacts list or address book 704, collaboration groups 706, a calendar 708, an announcement configuration control 710, and an inbox 716.

The user, or moderator, can activate the announcement configuration control 710 to prepare one or more announcements as discussed above. In some embodiments, the configuration control will further include a window that allows the user to see his announcements. In addition, as discussed above, in certain embodiments, the announcements are of message formats or calendar updates. These are shown at 714, where an announcement has been received and is waiting in the user's inbox 716, and at 712, where an announcement calendar update is shown.

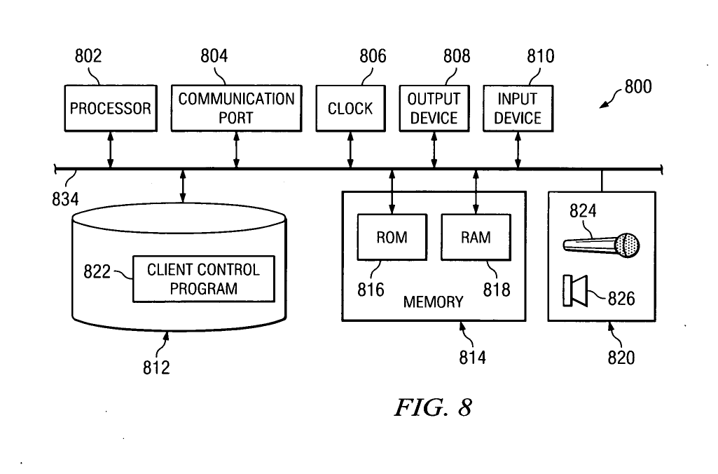

Now referring to FIG. 8, a representative block diagram of an exemplary computer or processing device 800 suitable for use as a user device or a server according to embodiments of the present invention is shown. In particular, the computer 800 may be a device suitable for accessing or implementing a service or clients in accordance with embodiments of the present invention. In some embodiments, the computer 800 may include or operate a web browser or multimedia messaging system or clients. The computer 800 may be embodied as a single device or computer, a networked set or group of devices or computers, a workstation, mainframe or host computer, etc. In some embodiments, the computer 800 may implement one or more elements of the methods disclosed herein.

The computer 800 may include a processor, microchip, central processing unit, or computer 802 that is in communication with or otherwise uses or includes one or more communication ports or network interfaces 804 for communicating with user devices and/or other devices. The communication ports 804 may include such things as telephone adapters, local area network adapters, wireless communication devices, Bluetooth technology, etc. The computer 800 also may include an internal clock element 806 to maintain an accurate time and date for the computer 800, create time stamps for communications received or sent by the computer 800, etc.

If desired, the computer 800 may include one or more output devices 808 such as a printer, infrared or other transmitter, antenna, display screen or monitor, text to speech converter, speaker, etc., as well as one or more input devices 810 such as a bar code reader or other optical scanner, infrared or other receiver, antenna, magnetic stripe reader, image scanner, roller ball, touch pad, joystick, touch screen, computer keyboard, computer mouse, microphone, etc. In some embodiments, the computer 800 may include a telephony interface 820 including, for example, a microphone 824 and speaker 826.

In addition to the above, the computer 800 may include a memory or data storage device 812 to store information, software, databases, documents, communications, device drivers, etc. The memory or data storage device 812 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, an optical disk such as a compact disc or DVD and/or a hard disk. Thus, the storage device 812 may include various combinations of moveable and fixed storage. The computer 800 also may include memory 814, such as ROM 816 and RAM 818.

The processor 802 and the data storage device 812 in the computer 800 each may be, for example: (i) located entirely within a single computer or other computing device; or (ii) connected to each other by a remote communication medium, such as a serial port cable, telephone line or radio frequency transceiver. In one embodiment, the computer 800 may be implemented as one or more computers that are connected to a remote server computer, as will be explained in greater detail below.

A conventional personal computer or workstation with sufficient memory and processing capability may be used as the computer 800. The computer 800 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 802. Other suitable processors may be available from Motorola, Inc., AMD, or Sun Microsystems, Inc. The processor 802 also may be embodied as one or more microprocessors, computers, computer systems, etc.

Software may be resident and operating or operational on the computer 800. The software may be stored on the data storage device 812 and may include one or more control programs 822. The control programs 822 may implement the various services and clients described herein.

It is noted that, while illustrated as software stored in storage medium 812, the various control modules in accordance with embodiments of the present invention may also include related firmware and/or hardware components. Thus, the figure is exemplary only.

The control program 822 may control the processor 802. The processor 802 may perform instructions of the control program 822, and thereby operate in accordance with the methods described in detail herein. The control programs may be stored in a compressed, uncompiled and/or encrypted format. The control programs furthermore include program elements that may be necessary, such as an operating system, a database management system and device drivers for allowing the processor 802 to interface with peripheral devices, databases, etc. Appropriate program elements are known to those skilled in the art, and need not be described in detail herein.

According to some embodiments, the instructions of the control program may be read into a main memory from another computer-readable medium, such as from the ROM 816 to the RAM 818. Execution of sequences of the instructions in the control program causes the processor 802 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 802, communication ports 804, clock 806, output device 808, input device 810, data storage device 812, ROM 816 and RAM 818 may communicate or be connected directly or indirectly in a variety of ways. For example, the processor 802, communication ports 804, clock 806, output device 808, input device 810, data storage device 812, ROM 816 and RAM 818 may be connected via a bus 834.

While specific implementations and hardware/software configurations for the computer 800 have been illustrated, it should be noted that other implementations and hardware configurations are possible and that no specific implementation or hardware/software configuration is needed. Thus, not all of the components illustrated in FIG. 8 may be needed for the computer 800 implementing the methods disclosed herein.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

What is claimed is:

1. A telecommunications system, comprising:
a network;
a plurality of user devices operably coupled to the network; and
a teleconferencing system operably coupled to the network, the teleconferencing system including a hosting service configured to allow a moderator to set up and schedule a teleconference among a plurality of participant user devices and an announcement service configured to allow for distributing moderator-defined information to the participants by automatically sending the moderator information as moderator-selected media upon a log in to the conference.

2. A telecommunications system in accordance with claim 1, said teleconferencing system including a multimedia conferencing system, wherein the announcement service includes means for specifying an announcement medium.

3. A telecommunications system in accordance with claim 2, further including a calendar service, wherein an announcement update includes a calendar update.

4. A telecommunications system in accordance with claim 1, wherein said announcement service is configured to distribute moderator-defined information prior to the conference.

5. A telecommunications method, comprising:
configuring and scheduling a teleconference;
defining a moderator announcement;
delivering the moderator announcement to parties entering the conference responsive to parties logging in to the conference.

6. A telecommunications method in accordance with claim 5, wherein the defining a moderator announcement comprises recording an audio announcement prior to the beginning of the conference.

7. A telecommunications method in accordance with claim 5, wherein the defining a moderator announcement comprises recording an audio announcement while the conference is ongoing.

8. A telecommunications method in accordance with claim 5, wherein the defining a moderator announcement comprises defining a moderator-selected medium for delivering the announcement.

9. A telecommunications method in accordance with claim 8, further including delivering the announcement according to the moderator-selected medium prior to the start of the conference.

10. A telecommunications system, comprising:
a teleconferencing setup system configured to allow a moderator to set up and schedule a teleconference;
an authentication unit configured to permit participants to the conference to register for the conference; and
a moderator information distribution means for distributing moderator-defined information to the participants by automatically sending the moderator information as moderator-selectable media.

11. A telecommunications system in accordance with claim 10, wherein the moderator information is sent responsive to the authentication unit detecting a registration of a party.

12. A telecommunications system in accordance with claim 10, wherein the moderator-selectable media comprises audio media.

13. A telecommunications system in accordance with claim 10, wherein the moderator-selectable media comprises e-mail.

14. A telecommunications system in accordance with claim 10, wherein the moderator-selectable media comprises a calendar service update.

15. A telecommunications system in accordance with claim 10, wherein the moderator information distribution means is configured to distribute the announcement as a first medium prior to the beginning of a conference and as a second medium upon a participant logging in to the conference.
